(19) United States
(12) Patent Application Publication
(10) Pub. No.: US 2017/0028783 A1
(43) Pub. Date: Feb. 2, 2017

(54) METHOD OF MANUFACTURING PNEUMATIC TIRE AND PNEUMATIC TIRE

(71) Applicant: TOYO TIRE & RUBBER CO., LTD., Osaka (JP)

(72) Inventor: Tomohiro Hitotsuyanagi, Osaka (JP)

(73) Assignee: TOYO TIRE & RUBBER CO., LTD., Osaka (JP)

(21) Appl. No.: 15/221,054

(22) Filed: Jul. 27, 2016

(30) Foreign Application Priority Data
Jul. 29, 2015 (JP) 2015-150094

(51) Int. Cl. B60C 9/20; B29D 30/30

(52) U.S. Cl. CPC B60C 9/20; B29D 30/3042; B60C 2009/2016; B60C 2009/2061; B60C 2200/06

(57) ABSTRACT

A method of manufacturing a pneumatic tire includes preparing a belt forming member formed of belt cords arranged parallel and covered with rubber. In a development state, the belt forming member is formed into a parallelogram, so that in a state wound with the belt cords extending in a direction inclined at a cord angle θ, the belt forming member is formed into a circular cylindrical configuration where a belt-under diameter D is not smaller than 940 mm and not larger than 960 mm and a belt width W is not smaller than 270 mm and not larger than 310 mm, and the cord angle θ, the belt-under diameter D and the belt width W satisfy a relationship of 0.577 πD≦W/tanθ<1.07πD. The belt forming member is wound and joined at a joint portion where the inclined sides are brought into contact with each other.

### CROSS-REFERENCE TO RELATED APPLICATION

This application claims priority of Japanese Patent. Application No. 2015-150094 filed on Jul. 29, 2015, the content of which is incorporated herein by reference.

### BACKGROUND OF THE INVENTION

Technical Field

The present invention relates to a method of manufacturing a pneumatic tire and a pneumatic tire.

Related Art

In a pneumatic radial tire for a heavy load used for a vehicle such as a truck or a bus, it has been known that a belt layer arranged between a carcass and a tread portion includes a reinforcement belt with cords having a small inclination angle with respect to the tire-circumferential direction cord angle) of 0 to 5 degrees (see Japanese Patent No. 5182455, JP 2012-196994 A, for example). The reinforcement belt is intended to suppress a growth of the tire in the radial direction.

### SUMMARY OF THE INVENTION

The reinforcement belt disclosed in JP 2012-196994 A is formed by coating a plurality of steel cords disposed parallel to each other over the entire length of the reinforcement belt by rubber. In a development state, the reinforcement belt is formed into a parallelogram which has: circumferential direction sides having the same length and extending parallel to the tire circumferential direction; and inclined sides inclined with respect to the tire circumferential direction at a small angle and extending parallel to the steel cords. The reinforcement belt is formed into a circular cylindrical shape by joining the inclined sides which face each other when wound at a joint portion where the inclined sides are brought into contact with each other.

The cord angle is a small angle in the reinforcement belt and hence, the joint portion which is parallel to the belt cords becomes extremely long whereby there may be a case where the joint portion extends over an approximately one turn or more in the circumferential direction of the tire depending on a belt-under diameter and a belt width. In this case, the joint portion of the reinforcement belt and a joint portion of another belt (for example, a main working belt, a protection belt, buffer belt or the like) are liable to be disposed with a positional relationship where the joint portion of the reinforcement belt and the joint portion of another belt intersect (overlap) with each other when the belt layer is viewed in a tire radial direction.

Further, along with the considerable increase of the length of the joint portion, it is not easy to snugly joint the inclined sides over the whole joint length and hence, irregularities are liable to occur in shape of the joint portion. As a result, when the joint portions intersect with each other among a plurality of belts, the uniformity of the tire at the intersecting portion is liable to be deteriorated in combination with the irregularities in shape of the joint portions. As a result, durability of the belt is deteriorated.

It is an object of the present invention to provide a method of manufacturing a pneumatic tire and a pneumatic tire where a reinforcement belt can be disposed in a belt layer without deteriorating the uniformity of the tire and the belt durability.

An aspect of the present invention provides a method of manufacturing a pneumatic tire where a reinforcement belt is disposed in a belt layer wound outside a carcass ply in a tire radial direction, the method comprising preparing a belt forming member formed of belt cords arranged parallel to each other and covered with rubber, wherein in a development state, the belt forming member is formed into a parallelogram which has circumferential direction sides extending parallel to the tire circumferential direction and inclined sides extending parallel to the belt cords, so that in a state where the belt forming member is wound with the belt cords extending in a direction inclined with respect to a tire circumferential direction at a cord angle θ, the belt forming member is formed into a circular cylindrical configuration where a belt-under diameter D is not smaller than 940 mm and not larger than 960 mm and a belt width W is not smaller than 270 mm and not larger than 310 mm, and wherein the cord angle θ, the belt-under diameter D and the belt width W satisfy a relationship of 0.57 πD ≦W/tanθ<1.0 πD, winding the belt forming member in a circular cylindrical shape, and joining the inclined sides which face each other to each other at a joint portion where the inclined sides are brought into contact with each other to form the reinforcement belt.

According to the present invention, in a development state of the reinforcement belt, the tire circumferential direction length (W/tanθ) of the inclined side of the belt forming member is set to a value which is 0.57 times or more and less than 1.0 times as large as the belt-under circumference length (ED) and hence, when the reinforcement belt is wound in a circular cylindrical shape, there is no possibility that the joint portion is formed exceeding one turn in the tire circumferential direction. Accordingly, it is possible to easily prevent the joint portion of the reinforcement belt and the joint portion of another belt from being arranged with the positional relationship where the joint portion of the reinforcement belt and the joint portion of another belt intersect (overlap) with each other when the belt layer is viewed in a tire radial direction and hence, the deterioration of the uniformity of the tire can be prevented. As a result, the deterioration of the belt durability is prevented.

Further, the belt-under diameter D is set to a value of not smaller than 940 and not larger than 960 mm, and the belt width W is set to a value of not smaller than 270 mm and not larger than 310 mm. Accordingly, it is possible to set a cord angle θ of the reinforcement belt to an angle of not smaller than approximately 5 degrees and not larger than approximately 10 degrees in accordance with 0.57 πD <W/_{tanθ<}1.0 πD. Accordingly, a growth of the tire in a radial direction can be properly suppressed by the reinforcement belt.

As describe above, according to the method of manufacturing a pneumatic tire of the present invention, the reinforcement belt can be disposed in the belt layer without deteriorating the uniformity of the tire and the belt durability.

Preferably, the cord angle θ, the belt-under diameter D and the belt width W satisfy a relationship of 0.577 πD≦W/tanθ<0.9 πD.

There is no possibility that the reinforcement belt is wound exceeding 0.9 turn in the tire circumferential direction. Accordingly, it is possible to avoid more easily the intersecting between the joint portion of the reinforcement belt and the joint portion of another belt.

Preferably, the cord angle 0 is not smaller than 6 degrees and not larger than 9 degrees.

By setting the cord angle to an angle of not smaller than 6 degrees and not larger than 9 degrees while preventing the formation of the joint portion of the reinforcement belt one turn or more in the tire circumferential portion, a binding force in the tire radial direction generated by the reinforcement belt can be set to a proper value and hence, the excessive deformation of the tire in the tire width direction can be suppressed. As a result, distortion generated in a bead portion can be suppressed thus enhancing bead durability.

Another aspect of the present invention provides a pneumatic tire comprising a reinforcement belt disposed in a belt layer wound outside a carcass ply in a tire radial direction, wherein the reinforcement belt is formed of a belt forming member formed of belt cords arranged parallel to each other and covered with rubber, wherein in a development state, the belt forming member is formed into a parallelogram which has circumferential direction sides extending parallel to the tire circumferential direction and inclined sides extending parallel to the belt cords, so that in a state where the belt forming member is wound with the belt cords extending in a direction inclined with respect to a tire circumferential direction at a cord angle θ, the belt forming member is formed into a circular cylindrical configuration where a belt-under diameter D is not smaller than 940 mm and not larger than 960 mm and a belt width W is not smaller than 270 mm and not larger than 310 mm, and the cord angle θ, the belt-under diameter D and the belt width W satisfy a relationship of of 0.57 πD≦W/tanθ<1.0 πD, and wherein the reinforcement belt has a joint portion where the inclined sides which face each other in a state where the belt forming member is wound in a circular cylindrical shape are brought into contact with each other.

The pneumatic tire can have an aspect ratio of not larger than 70% and a nominal section width of not smaller than 365.

According to the method of manufacturing a pneumatic tire and the pneumatic tire of the present invention, the reinforcement belt can be disposed inside the belt layer without deteriorating the uniformity of the tire and the belt durability.

### BRIEF DESCRIPTION OF THE DRAWINGS

The foregoing and the other features of the present invention on will become apparent from the following description and drawings of an illustrative embodiment of the invention in which:

FIG. 1 is a meridian cross sectional view of a pneumatic tire according to an embodiment of the present invention;

FIG. 2 is a development view of a belt layer;

FIG. 3A is a schematic view of a reinforcement belt showing a development state of the reinforcement belt;

FIG. 3B is a schematic view of a reinforcement belt showing a state where the reinforcement belt is wound into a circular cylindrical shape;

FIG. 4A and FIG. 48 are development views of the reinforcement belt schematically showing a joint portion according to an embodiment, of the present invention; and

FIG. 5 is a schematic partial cross-sectional view of the pneumatic tire when a load is applied to the tire.

### DETAILED DESCRIPTION OF THE INVENTION

Hereinafter, an embodiment of the present invention is described with reference to attached drawings.

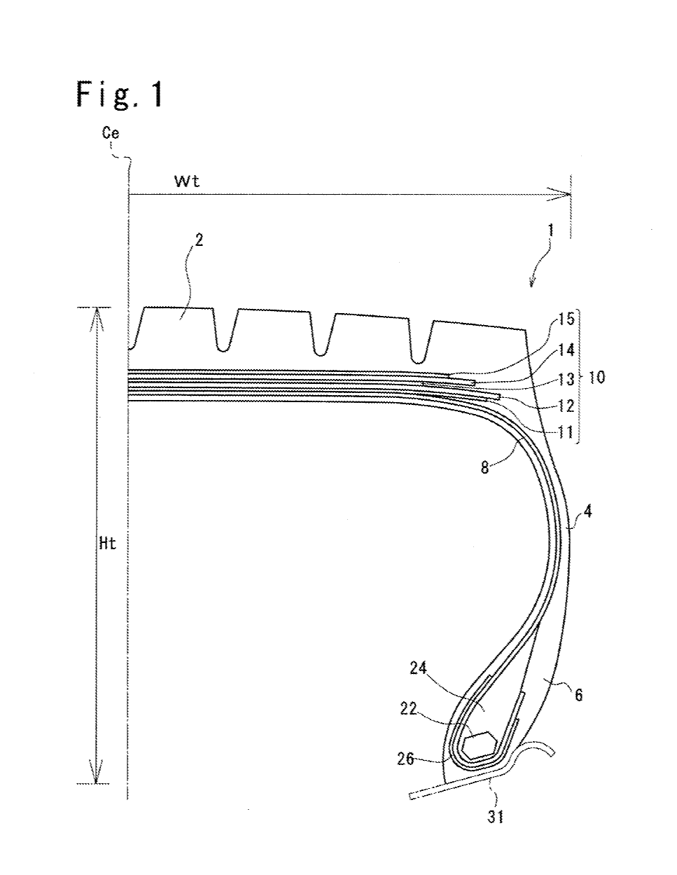

FIG. 1 shows a rubber pneumatic tire (hereinafter referred to as “tire”) 1 according to an embodiment of the present invention. The tire 1 is a pneumatic radial tire for a heavy load used for a vehicle such as a truck or a bus. Further, the tire 1 is a low-profile tire having an aspect ratio of not larger than 70%. An aspect ratio is defined as a ratio of a maximum tire-section height Ht to a maximum tire-section width Wt. Specifically, a size of the tire 1 in this embodiment is 445/50R22.5 (expressed in accordance with ISO standard).

The tire 1 includes a tread portion 2, a pair of side portions 4, and a pair of bead portions 6. The bead portions 6 are respectively formed on inner edge portions of the side portions 4 in a tire-radial direction (edge portions of the side portions 4 opposite to the tread portion 2). A carcass 8 is arranged between the pair of bead portions 6. An inner liner (not shown in the drawing) is arranged in an innermost peripheral surface of the tire 1. A belt layer 10 is arranged between the carcass 8 and a tread surface of the tread portion 2. In other words, in the tread portion 2, the belt layer 10 is arranged at an outer side of the carcass 8 in the tire-radial direction. As described later in detail, in this embodiment, the belt layer 10 includes five belts 11 to 15.

The bead portion 6 includes a bead core 22, a bead filler 24, and a chafer 26. Around the bead core 22, an end portion of the carcass 8 in a tire-width direction is wound up from an inner side to an outer side in a tire-width direction along the bead filler 24. The chafer 26 is arranged around the bead filler 24 so as to be arranged adjacently to an outer side of the end portion of the carcass 8.

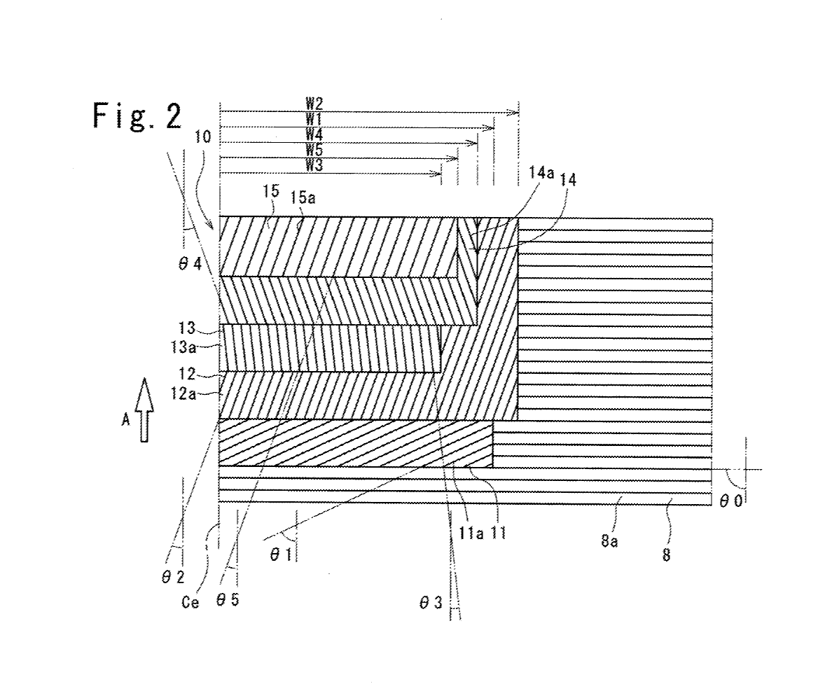

Referring to FIGS. 1 and 2, the carcass 8 in this embodiment is formed of one carcass ply, and is formed of a plurality of carcass cords 8a arranged parallel to each other and coated by a rubber layer. Each carcass cord 8a is arranged so as to extend in the tire-radial direction, and has an angle θ0 with respect to a tire-circumferential direction (cord angle) set to 90 degrees. In FIGS. 1 and 2, symbol Ce indicates a center line in the tire-width direction. The direction along which the center line Ce extends is a tire-radial direction. While the carcass cord 8a in this embodiment is made of steel, the carcass cord 8a can be made of organic fibers.

Referring to FIGS. 1 and 2, the belt layer 10 in this embodiment includes five belts arranged in an overlapping manner. These belts include a buffer belt 11, a first main working belt 12, a reinforcement belt 13, a second main working belt 14, and a protection belt 15.

The buffer belt 11 is arranged adjacently to an outer side of the carcass 8 in the tire-radial direction. The first main working belt 12 is arranged adjacently to an outer side of the buffer belt 11 in the tire-radial direction. The second main working belt 14 is arranged at an outer side of the first main working belt 12 in the tire-radial direction. The reinforcement belt 13 is arranged between the first main working belt 12 and the second main working belt 14. That is, the reinforcement belt 13 is arranged adjacently to the outer side of the first main working belt 12 in the tire-radial direction, and is also arranged adjacently to an inner side of the second main working belt 14 in the tire-radial direction. The protection belt 15 is arranged adjacently to an outer side of the second main working belt 14 in the tire-radial direction.

Main functions of the first and second main working belts 12 and 14 are to apply a binding force in the tire-radial direction to the carcass 8 (with a cord angle θ0 being set to 90 degrees). A main function of the reinforcement belt 13 is to compensate for the shortage in a binding force in the tire-radial direction which is applied to the tire 1 by the first and second main working belts 12 and 14. A main function of the protection belt 15 is to enhance external damage resistance of the tire 1 by protecting the first and second main working belts 12 and 14. A main function of the buffer belt 11 is to enhance impact resistance of the tire 1.

Each of these belts 11 to 15 is formed of a plurality belt cords 11a, 12a, 13a, 14a, and 15a arranged parallel to each other with extending in a direction inclined with respect to a tire circumferential direction and coated by a rubber layer.

Referring to FIG. 2, inclination angles (cord angles) θ to θ5 of the belt cords 11 ato 15a of belts 11 to 15 forming the belt layer 10 will be described. In the description hereinafter, regarding the cord angles θ1 to θ5, a direction along which the belt cords ha to 15a extend rightward and away from the center line Ce in the tire-width direction when an arrow A in FIG. 2 is set as a reference direction can be referred to as “right upward direction”. Similarly, a direction along which the belt cords 11a to 15a extend leftward and away from the center line Ce in the tire-width direction when the allow A in FIG. 2 is set as the reference direction can be referred to as “left upward direction”.

In this embodiment, the cord angle θof the belt cord 12a of the first main working belt 12 is set to 17 degrees (right upward direction). The cord angle 02 can be set to any value which falls within a range of 20±10 degrees, and can preferably be set to a value which falls within a range of 17±5 degrees.

In this embodiment, the cord angle θ4 of the belt cord 14a l of the second main working belt 14 is set to 17 degrees (left upward direction). The cord angle θ4 can be set to a value which falls within a range of 20±10 degrees, and can preferably be set to a value which falls within a range of 17±5 degrees.

The cord angles θ2 and θ4 of the first and second main working belts 12, 14 are set so that the belt cords 12a and 14a extend in different directions with respect to the center line Ce in the tire-width direction. That is, one of the cord angles θ2 and θ4 is set so that the belt cords extend in the right upward direction, and the other of them is set so that the belt cords extend in the left upward direction.

The cord angle θ3 of the belt cord 11a of the buffer belt 11 is set to 65 degrees in this embodiment. The cord angle θ1 can be set to a value which falls within a range of 60±15 degrees.

The cord angle θ5 of the belt cord 15a of the protection belt 15 is set to 20 degrees in this embodiment. The cord angle θ5 can be set to a value which falls within a range of 20±10 degrees,

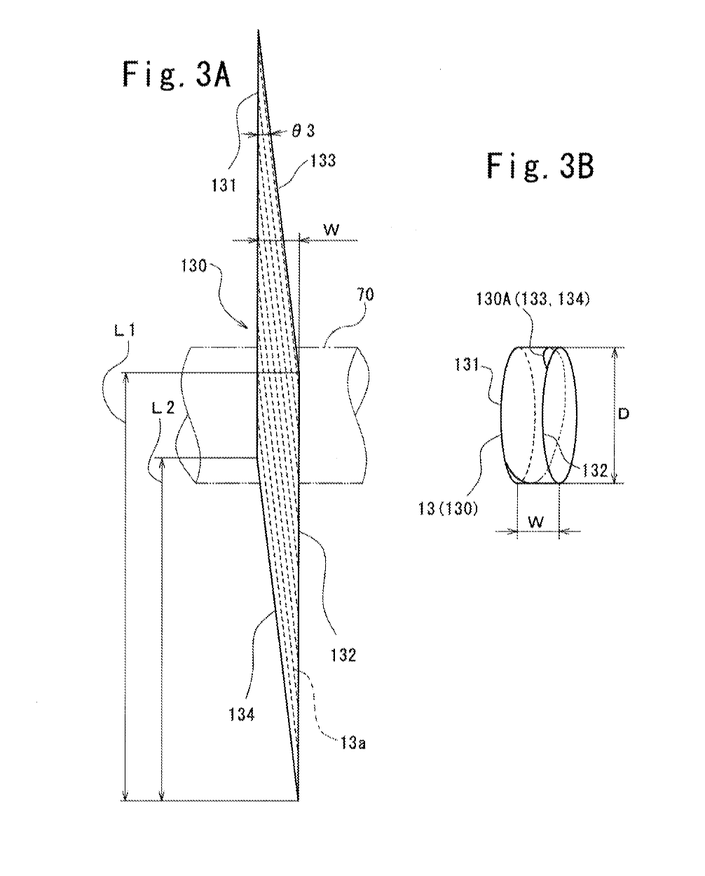

The cord angle θ3 of the belt cord 13a of the reinforcement belt 13 is described with reference to FIG. 3A and FIG. 3B. FIG. 3A and FIG. 3B are schematic views of the reinforcement belt 13, wherein FIG. 3A shows a development state of the reinforcement belt 13, and FIG. 3B shows a state where the reinforcement belt 13 is wound into a circular cylindrical shape. Firstly, referring to FIG. 3A, in a development state of the reinforcement belt 13, the reinforcement belt 13 is configured as a reinforcement belt forming member 130 having a parallelogram which has a pair of circumferential direction sides 131, 132 extending parallel to the tire circumferential direction when the reinforcement belt 13 is wound, and a pair of inclined sides 133, 134 extending parallel to the belt cords 13a.

Further, the reinforcement belt forming member 130 is wound around a forming drum 70 (indicated by an imaginary line only in FIG. 3A) such that the circumferential direction sides 131, 132 extend parallel to a tire circumferential direction (drum circumferential direction), and the facing inclined sides 133, 134 are joined to each other at a joint portion 130A where the inclined sides 133, 134 are brought into contact with each other. With such a configuration, the reinforcement belt 13 having a circular cylindrical shape shown in Fig, 3B is formed.

That is, to prepare the reinforcement belt forming member 130 which can form the circular cylindrical reinforcement belt 13 when the reinforcement belt forming member 130 is wound by one turn, assuming a belt-under diameter of the reinforcement belt 13 as D and a belt width of the reinforcement belt 13 as W, a length L1 of each circumferential direction sides 131, 132 is set to a belt-under circumference length πD, and a distance between the circumferential direction sides 131, 132 is set to the belt width W of the reinforcement belt 13 in a wound state. Further, a tire circumferential direction length L2 of the inclined sides 133, 134 is calculated by a formula W/tanθ3 based on the belt width W and a cord angle θ3 of the belt cord 13a.

The cord angle θ3 is set such that the tire circumferential direction length L2 of the inclined sides 133, 134 is set to a value which is 0.57 times or more and less than 1.0 times as large as the length L1 of the circumferential direction sides 131, 132. That is, to express a relationship among the belt-under diameter D, the belt width W and the cord angle θ3 of the reinforcement belt 13 by a formula, the relationship of 0.57 πD≦W/tanθ3<1.0 πD is established. As a result, the joint portion 130A where the inclined sides 133, 134 of the reinforcement belt 13 are brought into contact with each other extends in a spiral manner in a circumferential direction and in a width direction in the belt layer 10. To be more specific, the joint portion 130A traverses the reinforcement belt 13 from the circumferential direction side 131 to the circumferential direction side 132 over the entire width W of the reinforcement belt 13 in the belt width direction. However, the joint portion 130A does not traverse the reinforcement belt 13 exceeding one turn in the tire circumferential direction.

The belt-under diameter D is set to a value of not smaller than 940 mm and not larger than 960 mm, and the belt width W is set to a value of not smaller than 270 mm and not larger than 310 mm. Accordingly, the cord angle θ3 is set to an angle of not smaller than 5 degrees and not larger than 10 degrees (rounded to the nearest integer) based on the above-mentioned formula 0.57 πD≦W/tanθ3<1.0 πD. In this embodiment, the belt-under diameter D is set to 950 mm, the belt width W is set to 290 mm, and the length L2 (W/tanθ3) of the inclined sides 133, 134 of the reinforcement belt forming member 130 is set to a value 0.8 times as large as the length L1 (πD) of the circumferential direction sides 131, 132 in the tire circumferential direction. As a result, the cord angle θ3 is set to approximately 7 degrees.

Each of the belts 11, 12, 14, 15 has a parallelogram in the substantially same manner as the reinforcement belt 13 in a development state, and inclined sides of each belt (not shown in the drawing) are joined to each other at a joint portion where the inclined sides are brought into contact with each other. Numerical values (including upper and lower limit values of a numerical value range) of the cord angles θ1 to θ5 can include substantially unavoidable errors, and are not necessarily geometrically precise values as long as the functions required for the belts 11 to 15 are satisfied. This is also applied to the cord angle θ0 of the carcass cords 8a.

The cord angles θ1 to θ5 of the belts 11 to 15 can be coordinated as shown in the following Table 1.

TABLE 1

| | Embodiment | Settable range of angle |
|---|---|---|
| Buffer belt | 65 degrees | 60 ± 15 degrees |
| | (right upward direction) | (right upward direction) |
| First main | 17 degrees | 20 ± 10 degrees (17 ± 5 degrees) |
| working belt | (right upward direction) | (right upward direction) |
| Reinforcement | 7 degrees | Not smaller than 5 degrees and |
| belt | (left upward direction) | not larger than 10 degrees |
| Second main | 17 degrees | 20 ± 10 degrees (17 ± 5 degrees) |
| working belt | (left upward direction) | (left upward direction) |
| Protection | 20 degrees | 20 ± 10 degrees |
| belt | (right upward direction) | (right upward direction) |

As described above, in a state where the reinforcement belt 13 is wound, the belt-under diameter D is set to a value of not smaller than 940 mm and not larger than 960 ram, and the belt width W is set to a value of not smaller than 270 mm and not larger than 310 mm. Further, in a state where the reinforcement belt 13 is developed, the length L2 (W/tanθ3) of the inclined sides 133, 134 in the tire circumferential direction is set to a value which is 0.57 times or more and less than 1.0 times as large as the length L1 (πD) of the circumferential direction sides 131, 132.

As a result, in the reinforcement belt 13, the joint portion 130A is not formed exceeding one turn and hence, the cord angle θ3 is set to an angle of not smaller than 5 degrees and not larger than 10 degrees. Since the joint portion 130A of the reinforcement belt 13 is not formed exceeding one turn, it is possible to easily prevent the joint portion 130A and joint portions of other belts 11, 12, 14, 15 in the belt layer 10 from being arranged to take the positional relationship where the joint portion 130A and the joint portions of other belts 11, 12, 14, 15 intersect (overlap) with each other when the belt layer 10 is viewed in a radial direction.

Accordingly, by preventing the intersecting between the joint portions in the belt layer 10, it is possible to prevent the deterioration of the uniformity of the tire brought about by the intersecting of the joint portions where irregularities in shape are liable to occur and, as a result, the deterioration of belt durability can be suppressed.

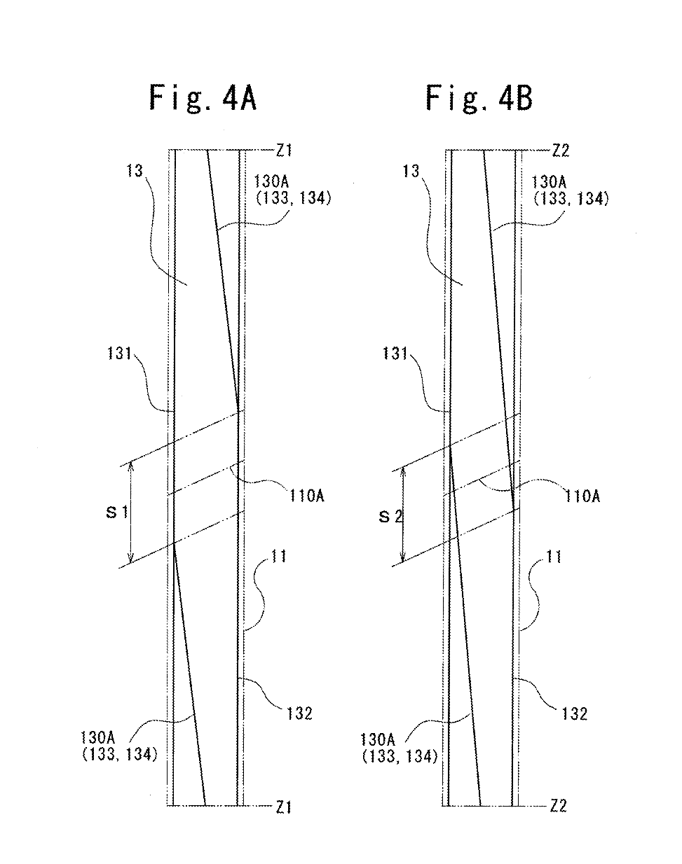

FIG. 4A and FIG. 4B are development view of the reinforcement belt 13 where one turn of the reinforcement belt 13 in the tire circumferential direction is shown. That is, in FIG. 4A, the reinforcement belt 13 is continuously formed at a Z1 position on an upper end of the drawing and a Z1 position on a lower end of the drawing. In FIG. 4B, the reinforcement belt 13 is continuously formed at a Z2 position on an upper end of the drawing and a Z2 position on a lower end of the drawing. Firstly, referring to FIG. 4A, in this embodiment, the joint portion 130A of the reinforcement belt 13 extends in a spiral manner from the circumferential direction side 131 to the circumferential direction side 132 on the other side. Although the joint portion 130A is formed by 0.8 turn in the tire circumferential direction, the joint portion 130A is not formed exceeding one turn in the tire circumferential direction.

Accordingly, when the reinforcement belt 13 is viewed from an extending direction of the belt cords of other belts in the belt layer 10, the joint portion 130A is not positioned in an overlapping manner with the joint portions of other belts and, particularly, the joint portion 130A does not exist in a region S1. Accordingly, by arranging the joint portions of other belts in the region S1, it is possible to prevent the joint portion 130A of the reinforcement belt 13 and the joint portions of other belts from being positioned in an intersecting (overlapping) manner when the belt layer 10 is viewed in the tire radial direction.

For example, the description is made by taking, as an example, a case of the buffer belt 11 where a cord angle θ1 largely differs from the cord angle θ3 of the reinforcement belt 13. As shown in FIG. 4A, by positioning the joint portion 110A in the region S1, the intersecting of the joint. portion 110A with the joint portion 130A of the reinforcement belt 13 can be prevented. Further, when the joint portion 110A of the buffer belt 11 is positioned in a region other than the region S1, the joint portion 110A intersects with the joint portion 130A of the reinforcement belt 13 at one position. However, there is no possibility that the joint portion 110A intersects with the joint portion 130A at two or more positions.

To the contrary, as shown in FIG. 4B, when the joint portion is formed exceeding one turn (for example, 1.1 turn), it is difficult to avoid the intersecting between the joint portion 130A of the reinforcement belt 13 and the joint portion 110A of the buffer belt 11. For example, when the reinforcement belt 13 is viewed from an extending direction of the belt cord 11a, there is no region where the joint portion 130A is not positioned, and particularly in a region S2, the joint portion 130A is positioned in an overlapping manner.

Accordingly, the joint portion 110A of the buffer belt 11 intersects with the joint portion 130A of the reinforcement belt 13 at two positions in the region S2, and intersects with the joint portion 130A of the reinforcement belt 13 at one position in regions other than the region S2. Accordingly, in this case, the joint portion 110A of the buffer belt 11 intersects with the joint portion 130A of the reinforcement belt 13 at least at one position.

That is, by setting the length L2 (W/tanθ3) of the inclined sides 133, 134 in the tire circumferential direction to a value which is 0.57 times or more and less than 1.0 times as large as the length L1 of the circumferential direction sides 131, 132, it is possible to easily prevent the joint portion 130A of the reinforcement belt 13 and the joint portions of other belts in the inside of the belt layer 10 from intersecting with each other. Accordingly, the deterioration of the uniformity of the tire brought about by the intersecting of these joint portions can be prevented thus preventing the deterioration of the belt durability.

When a ratio of the length L2 to the length L1 is smaller than 0.57 (W/tanθ3<0.57 πD), the cord angle θ3 becomes larger than approximately 10 degrees and hence, a binding force of the reinforcement belt 13 in a radial direction is relatively lowered whereby there may be a case where a growth suppression function in the tire radial direction of the reinforcement belt 13 becomes insufficient. On the other hand, when the ratio of the length L2 to the length L1 is 1.0 or more (W/tanθ3≧1.0 πD), the joint portion 130A of the reinforcement belt 13 is formed on the circumferential portion of the tire in an extending manner exceeding one turn of the tire circumferential portion. As a result, the joint portion 130A of the reinforcement belt 13 is liable to intersect with the joint portions of other belts 11, 12, 14, 15 in the belt layer 10 so that the uniformity of the tire is liable to be deteriorated. As a result, the belt durability is deteriorated.

In the above-mentioned embodiment, the length L2 (W/tanθ3) of the inclined sides 133, 134 in the tire circumferential direction is set to a value which is 0.57 times or more and less than 1.0 times as large as the length L1 (πD) of the circumferential direction sides 131, 132. However, it is more preferable that the length L2 be set to a value which is 0.57 times or more and less than 0.9 times as large as the length L1. With such a configuration, an upper limit value of the length L2 of the joint portion 130A of the reinforcement belt 13 in the tire circumferential direction becomes smaller so that the intersecting (overlapping) between the joint portion 130A and the joint portions of other belts in the inside of the belt layer 10 can be avoided more easily.

In this case, the cord angle θ3 of the reinforcement belt 13 is not smaller than 6 degrees and not larger than 10 degrees by being rounded to a nearest integer and hence, a binding force of the reinforcement belt in a radial direction of the tire can be suitably lowered whereby the deformation of the tire in the tire width direction can be suppressed more easily and bead durability can be enhanced.

Main data of the belts 11 to 15 other than the cord angles in this embodiment are shown in the following Table 2.

TABLE 2

| | | | Cord thickness | | |
|---|---|---|---|---|---|
| | | | including | | |
| | | | covering | | |
| | | Cord | rubber | End | Belt |
| | Raw | diameter | thickness | number | width |
| | material | (mm) | (mm) | (EPI) | W (mm) |
| Buffer belt | Steel | 1.1 | 1.7 | 12 | W1 = 345 |
| First main | Steel | 1.4 | 2.6 | 12 | W2 = 370 |
| working belt | | | | | |
| Reinforcement | Steel | 1.1 | 1.7 | 12 | W3 = 290 |
| belt | | | | | |
| Second main | Steel | 1.4 | 2.6 | 12 | W4 = 325 |
| working belt | | | | | |
| Protection belt | Steel | 1.1 | 1.9 | 9 | W5 = 295 |

As shown in Table 2, in this embodiment, a width W4 (325 mm) of the second main working belt 14 which is arranged relatively outer side in the tire-radial direction is set narrower than a width W2 (370 mm) of the first main working belt 12 which is arranged relatively inner side in the tire-radial direction.

A width W3 of the reinforcement belt 13 is set to a value equal to or wider than 50% of a maximum tire-section width Wt (W3≧0.5 Wt). In this embodiment, the maximum tire-section width Wt is a value set under conditions where the tire 1 is mounted on a predetermined rim (a rim 31 is schematically shown in FIG. 1), the tire 1 is filled with air until an inner pressure reaches a predetermined internal pressure (830 kPa which is an internal pressure determined by the Tire and Rim Association, Inc (TRA)), and the tire 1 is in an unloaded state. The width W3 of the reinforcement belt 13 is set narrower than a width of either one of the first and second main working belts 12 and 14 having a narrower width than the other (W3<W2, W4). In this embodiment, the width W3 of the reinforcement belt 13 is set to 290 mm. Accordingly, the width W3 of the reinforcement belt 13 is equal to or wider than 50% of a maximum tire section width Wt (440 mm) under the above-mentioned conditions, and is narrower than the width W4 (325 mm) of the second main working belt 14 having a narrower width.

With respect to the range of the cord angle θ3 of the reinforcement belt 13, the belt-under diameter D, the belt width W and/or a ratio of L2 to L1 of the reinforcement belt 13 may be set such that the cord angle θ3 of the reinforcement belt 13 is set to an angle of not smaller than 6 degrees and not larger than 9 degrees. With such setting of the cord angle θ3 of the reinforcement belt 13, a binding force generated by the reinforcement belt 13 in the tire radial direction can be set to a further proper value.

The cord angle θ3 of the reinforcement belt 13 is not smaller than 6 degrees and not larger than 9 degrees, instead of a small angle of not smaller than 0 degrees to not more than 5 degrees (an angle which can be substantially regarded as 0 degrees or an angle close to 0 degrees). Such configuration can prevent a binding force in a tire-radial direction generated by a reinforcement belt 13 from becoming excessively large, and therefore the excessively large deformation of the tire in the tire-width direction can be suppressed. Since the excessively large deformation of the tire in the tire-width direction can be suppressed, the distortion generated in the bead portion 6 can be suppressed, and therefore bead durability (resistance against the generation of a defect such as separation in the bead portion) can be enhanced.

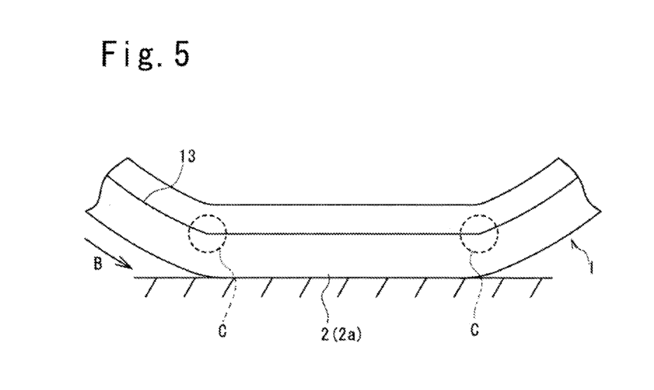

As conceptually shown in FIG. 5, in a loaded state (a state where the tire 1 is mounted on a vehicle), belt cords 13a of the reinforcement belt 13 are bent in regions (symbols C) of a tread surface of the tread portion 2 in front of and behind a road contact surface 2a in the rotational direction of the tire indicated by an arrow B. The smaller cord angle θ3, the more conspicuous the bending of the belt cords 13a becomes. By setting the cord angle θ3 to a value not smaller than 6 degrees and not larger than 9 degrees, compared to a case where the cord angle θ3 is set to a small angle such as an angle not smaller than 0 degrees and not larger than 5 degrees, bending of the belt cord 13a of the reinforcement belt 13 in the vicinity of the road contact surface 2a can be alleviated, and therefore cord breakage can be effectively prevented.

As described above, the width W3 of the reinforcement belt 13 is set narrower than the width W4 of the second main working belt 14 which is narrower one of the first and second main working belts 12, 14. Such configuration can also effectively prevent cord breakage of the belt cord 13a of the reinforcement belt.

As described above, the reinforcement belt 13 is arranged between the first main working belt 12 and the second main working belt 14. Due to such an arrangement, the reinforcement belt 13 is protected by the first and second main working belts 12, 14, and therefore cord breakage of the belt cord 13a of the reinforcement belt 13 caused due to bending of the cord in the vicinity of the road contact surface 2a (symbols C in FIG. 3) can be effectively prevented.

Due to these reasons, cord breakage of the reinforcement belt 13 can be effectively prevented.

By setting the cord angle θ3 of the reinforcement belt 13 to a value not smaller than 6 degrees and not larger than 9 degrees, an effect of suppressing a growth of the tire 1 in the radial direction is reduced compared to the case where the cord angle θ3 is set to a value not smaller than 0 degrees and not larger than 5 degrees. However, the cord angle θ3 of the reinforcement belt 13 is 9 degrees at maximum, and therefore there is no possibility that a binding force in the tire-radial direction is excessively reduced. Further, as described above, the width W3 of the reinforcement belt 13 is equal to or wider than 50% of a maximum tire-section width Wt. That is, a width of the reinforcement belt 13 is not narrow but is sufficiently wide. Due to these reasons, the tire 1 can ensure a required effect of suppressing a growth of the tire 1 in the radial direction, Further, the tire can acquire a sufficient force for holding a shape of the tread portion 2 so that distortion at the end portion of the belt can be reduced whereby the tire can ensure required belt durability. The width W3 of the reinforcement belt 13 is narrower than a width of the narrower one of the first and second main working belts 12 and 14 (widths W2, W4). Accordingly, the distortion generated in the reinforcement belt 13 can be reduced.

As described above, according to the tire 1 of the present embodiment, bead durability can be enhanced while an effect of suppressing a growth of the tire 1 in the radial direction and belt durability are also ensured.

The tire according to the present invention is favorably applicable to a pneumatic tire (so-called super single tire) having an aspect ratio of not larger than 70% and a nominal section width of not smaller than 365. The tire according to the present invention is also applicable to a pneumatic tire having a small aspect ratio and falling outer side a range of a pneumatic radial tire for heavy load.

What is claimed is:

1. A method of manufacturing a pneumatic tire where a reinforcement belt is disposed in a belt layer wound outside a carcass ply in a tire radial direction, the method comprising:
preparing a belt forming member formed of belt cords arranged parallel to each other and covered with rubber,
wherein in a development state, the belt forming member is formed into a parallelogram which has circumferential direction sides extending parallel to the tire circumferential direction and inclined sides extending parallel to the belt cords, so that in a state where the belt forming member is wound with the belt cords extending in a direction inclined with respect to a tire circumferential direction at a cord angle θ, the belt forming member is formed into a circular cylindrical configuration where a belt-under diameter D is not smaller than 940 mm and not larger than 960 mm and a belt width W is not smaller than 270 mm and not larger than 310 mm, and
wherein the cord angle θ, the belt-under diameter D and the belt width W satisfy a relationship of 0.57 πD W/tanθ<1.0 πD;
winding the belt forming member in a circular cylindrical shape; and
joining the inclined sides which face each other to each other at a joint portion where the inclined sides are brought into contact with each other to form the reinforcement belt.

2. The method of manufacturing a pneumatic tire according to claim 1, wherein the cord angle θ, the belt-under diameter D and the belt width W satisfy a relationship of 0.57 πD≦W/tanθ<0.9 πD.

3. The method of manufacturing a pneumatic tire according to claim 1, wherein the cord angle θ is not smaller than 6 degrees and not larger than 9 degrees.

4. A pneumatic tire comprising
a reinforcement belt disposed in a belt layer wound outside a carcass ply in a tire radial direction,
wherein the reinforcement belt is formed of a belt forming member formed of belt cords arranged parallel to each other and covered with rubber, wherein in a development state, the belt forming member is formed into a parallelogram which has circumferential direction sides extending parallel to the tire circumferential direction and inclined sides extending parallel to the belt cords, so that in a state where the belt forming member is wound with the belt cords extending in a direction inclined with respect to a tire circumferential direction at a cord angle θ, the belt forming member is formed into a circular cylindrical configuration where a belt-under diameter D is not smaller than 940 mm and not larger than 960 mm and a belt width W is not smaller than 270 mm and not larger than 310 mm, and the cord angle θ, the belt-under diameter D and the belt width W satisfy a relationship of of 0.57 πD W/tanθ<1.0 πD, and
wherein the reinforcement belt has a joint portion where the inclined sides which face each other in a state where the belt forming member is wound in a circular cylindrical shape are brought into contact with each other.

5. The pneumatic tire according to claim 4, wherein the pneumatic tire has an aspect ratio of not larger than 70% and a nominal section width of not smaller than 365.
